(19) United States
(12) Patent Application Publication
(10) Pub. No.: US 2007/0165495 A1
(43) Pub. Date: Jul. 19, 2007

(54) Heat assisted magnetic recording head

(75) Inventors: Myung-bok Lee, Suwon-si (KR); Jin-seung Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/501,828

(22) Filed: Aug. 10, 2006

(30) Foreign Application Priority Data
Jan. 13, 2006 (KR) 10-2006-0003939

(51) Int. Cl. G11B 11/00

(52) U.S. Cl. 369/13.33

(57) ABSTRACT

A heat assisted magnetic recording (HAMR) head is provided. The HAMR head is mounted in a slider having an ABS that faces a recording medium and illuminates light on the local area of the recording medium, and includes a recording unit that performs recording and a near field light emitter that illuminates near field light onto the local area of the recording medium, the near field light emitter including a light source, a waveguide, and a near field light emission (NFE) pole located between the recording unit and the waveguide, and which generates near field light that is illuminated on the recording medium using light transmitted through the waveguide.

### CROSS-REFERENCE TO RELATED PATENT APPLICATION

This application claims priority from Korean Patent Application No. 10-2006-0003939, filed on Jan. 13, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a heat assisted magnetic recording (HAMR) head, and more particularly, to an HAMR head including a near field light emitter having improved structure and arrangement.

2. Description of the Related Art

HAMR has been developed as a method of increasing a recording density of magnetic information recording. In HAMR, heat is applied to a local area of a recording medium to reduce coercive force, thereby allowing the recording medium to be easily magnetized by a magnetic field applied from a magnetic recording head. According to HAMR, it is possible to perform recording on a recording medium having high crystal magnetic anisotropy. With a medium having high crystal magnetic anisotropy, it is possible to achieve high thermal stability even when grains of the recording medium are small. As the recording density in magnetic recording increases, the sizes of grains constituting a recording bit should reduce in order to maintain a constant signal-to-ratio (SNR) of a recording medium. According to HAMR, it is possible to achieve a high recording density.

FIG. 1 is a schematic perspective view of a prior art HAMR head. Referring to FIG. 1, the HAMR head 1 applies heat on a local area of a recording medium 2 and illuminates a laser ray. The HAMR head 1 includes: a recording unit for converting information into a magnetic signal and applying the converted magnetic signal on the recording medium 2; a reproduction unit including a reproduction device 9 detecting a recorded bit from the recording medium 2; and a light source 6 for providing a light spot on the recording medium 2, for thermal assistance. The recording unit includes a recording pole 3 for applying a magnetic field on the recording medium 2, a return pole 4 constituting a magnetic circuit in cooperation with the recording pole 3, and an induction coil 5 inducing a magnetic field on the recording pole 3. Assuming that the recording medium 2 moves in a direction A, a laser ray illuminated from the light source 6 provides a light spot 7 on part of the recording medium 2, thereby reducing the coercive force of the part of the recording medium 2. The part of the recording medium exposed to the light spot 7 is magnetized by leakage magnetic flux generated from the recording pole 3. Information recorded in this manner is reproduced using the reproduction device 9 such as a giant magnetoresistance (GMR) device.

To perform high density recording using the HAMR head 1, the light spot formed on the recording medium 2 by a laser ray should be very small. For example, a light spot having a diameter of about 50 nm is required to realize a recording density 1 Tb/in². Accordingly, HAMR is studied to obtain a small light spot using a near field light. For such a technology, an HAMR head that adopts an aperture type near field light emitter element that emits near field light has been proposed. However, the aperture type near field light emitter element has a problem that transmittance efficiency is seriously reduced as the size of an aperture is reduced. Also, it is difficult to manufacture the aperture in parallel with an air-bearing surface (ABS), and there are difficulties related to a position alignment or manufacturing accuracy of the aperture having a small size of tens of nanometers (nm) during a manufacturing process. Furthermore, when a light source is located in the outside of a slider on which the HAMR head is mounted, the relative position of a coupler connecting light between the light source and a waveguide is not constant and unstable.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an HAMR head having a near field light emitter of a waveguide structure that is capable of being easily manufactured and improves a generation efficiency of near field light due to the structure and the arrangement of the near field light emitter.

According to an aspect of the present invention, there is provided an HAMR head mounted in a slider having an ABS that faces a recording medium, the heat assisted magnetic recording head including: a recording unit that performs magnetic recoding; and a near field light emitter that illuminates near field light onto a local area of the recording medium, wherein the near field light emitter includes: a light source located on one side of the slider; a waveguide, located on the side of the slider where the light source is located, whose side is located on the ABS, and having the recording unit located on the upper portion of the waveguide; and a near field light emission (NFE) pole located between the recording unit and the waveguide, that generates near field light to be illuminated on the recording medium using light transmitted through the waveguide.

### BRIEF DESCRIPTION OF THE DRAWINGS

The above and other aspects of the present invention will become more apparent by describing in detail exemplary embodiments thereof with reference to the attached drawings in which:

FIG. 1 is a schematic perspective view of a related art HAMR head;

FIG. 2 is a schematic sectional view of an HAMR head according to an exemplary embodiment of the present invention;

FIG. 3A is a schematic perspective view of a near field light emitter according to an exemplary embodiment of the present invention;

FIG. 3B is a sectional view taken along a line III-III of FIG. 3A;

FIG. 4 is a schematic sectional view of a light source arrangement according to an exemplary embodiment of the present invention;

FIG. 5 is a schematic sectional view of a first output coupler according to an exemplary embodiment of the present invention;

FIG. 6 is a schematic sectional view of a first output coupler according to another exemplary embodiment of the present invention;

FIG. 7 is a schematic sectional view of a near field light emission pole according to an exemplary embodiment of the present invention; and

FIG. 8 is a schematic sectional view of a near field light emission pole according to another exemplary embodiment of the present invention.

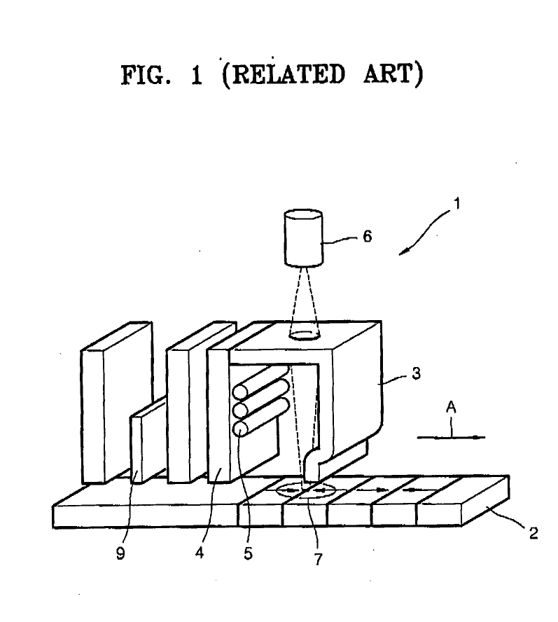

### DETAILED DESCRIPTION OF EXEMPLARY EMBODIMENTS OF THE INVENTION

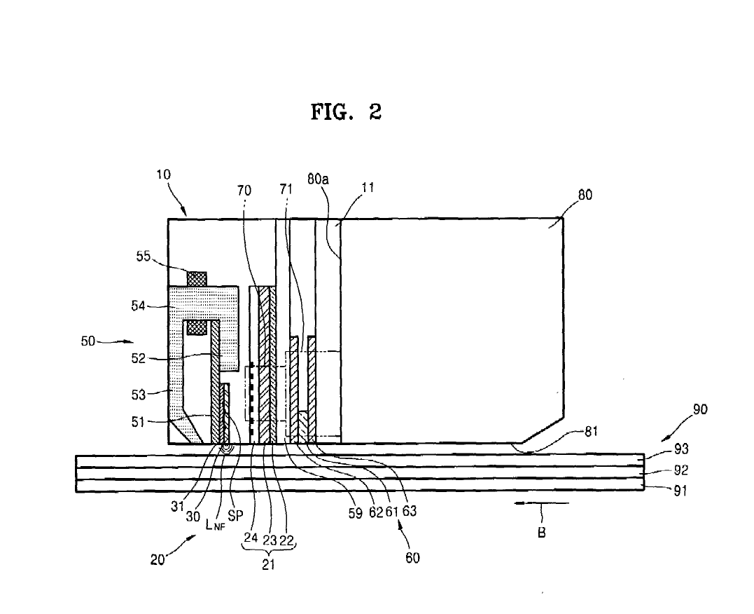

FIG. 2 is a schematic sectional view of an HAMR head according to an exemplary embodiment of the present invention.

Referring to FIG. 2, the HAMR head 10 includes a recording unit 50 provided on one side of a slider 80, and a near field light emitter 20.

The slider 80 has an ABS 81 that faces a recording medium 90 such that the slider 80 is floated by an active air pressure generated by relative movement of the slider 80 with respect to the recording medium 90.

The recording unit 50 includes a recording pole 51 magnetizing the recording medium 90, a return pole 53 spaced apart a certain distance from one side of the recording pole 51, a yoke 54 magnetically connecting the recording pole 51 with the return pole 53, and an induction coil 55 inducing a magnetic field to the recording pole 51. A shield layer 59 for shielding a stray magnetic field may be provided between the recording unit 50 and a substrate 11. Furthermore, a sub-yoke 52 may be provided on the other side of the recording pole 51 to help condense a magnetic flux to the end of the recording pole 51. The sub-yoke 52 has a stepped structure such that the end of the sub-yoke 52 that faces the ABS 81 has a step with respect to the end of the recording pole 51.

Also, the HAMR head 10 may be integrated together with a reproduction unit 60, which includes a reproduction device 61 such as a giant magnetoresistive (GMR) device, insulation layers 62 and 63 formed of non-magnetic materials surrounding the reproduction device 61. The HAMR head 10 and the reproduction unit 60 may be collectively manufactured through a thin film manufacturing process.

The recording medium 90 includes a base 91, a soft magnetic material layer 92 stacked on the base 91, and a recording layer 93 stacked on the soft magnetic material layer 92 and formed of a ferromagnetic material. An arrow B is a relative movement direction of the recording medium 90 with respect to the HAMR head 10.

The near field light, emitter 20 includes a light source 70 provided on one side 80a of the slider 80, a thin film type waveguide 21 provided on the one side 80a of the slider 80, and a near field light emission (NFE) pole 30.

The light source 70 illuminates light onto the NFE pole 30 through the waveguide 21. The light source 70 may be a laser diode, which is effective for exciting a surface plasmon (SP). A reference numeral 71 is a sub-mount in which the light source 70 is mounted. The light source 70 of the present invention is installed in the slider 80, which simplifies a structure transmitting light up to the NFE pole 30, and always maintains a constant optical coupling efficiency even when vibration or impulse occurs.

The waveguide 21 guides light emitted from the light source 70 to the NFE pole 30. The waveguide 21 is formed together with the recording unit 50 on the substrate 11 through a thin film process, and have a flat waveguide structure. The waveguide 21 is located such that the side of the waveguide 21 faces the ABS 81 on the one side 80a where the light source 70 is provided, and the recording unit 50 is located on the upper surface of the waveguide 21.

The NFE pole 30 is located between the recording unit 50 and the waveguide 21. According to the present exemplary embodiment, the NFE pole 30 is located in a space formed at the end of the sub-yoke 52 that faces the ABS 81. The NFE pole 30 is located such that the end of the NFE pole 30 and the end of the recording pole 51 are located on the same plane as that of the ABS 81.

The NFE pole 30 generates near field light L_{NF} to be illuminated onto the recording medium 90 using light transmitted through the waveguide 21.

The near field light emitter 20 is located between the recording pole 51 and the NFE pole 30 and may further include thermal conduction prevention layer 31 for blocking heat generated from the NFE pole 30. Such an arrangement makes it possible to form the thin film type waveguide 21 and the NFE pole 30 through a thin film process without remarkably changing a related art process of manufacturing a magnetic recording head manufactured through the thin film process. For modification of the present invention, both the waveguide 21 and the NFE pole 30 may be located in a space formed at the end of the sub-yoke 52 that faces the ABS 81.

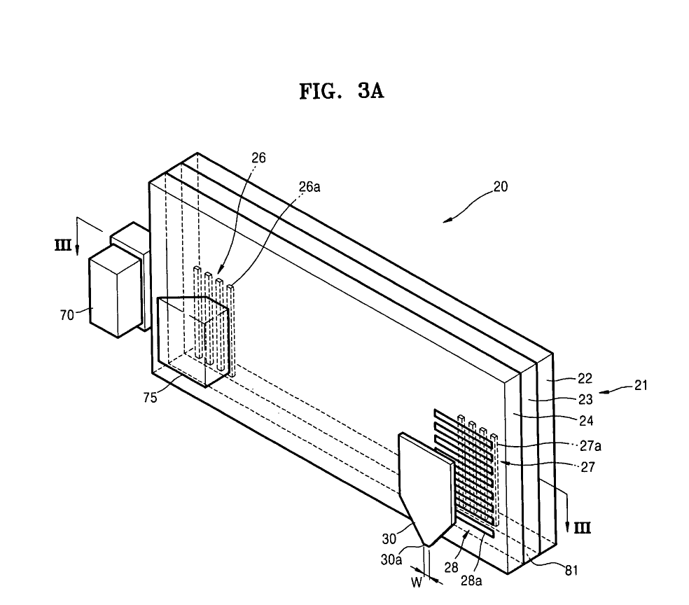

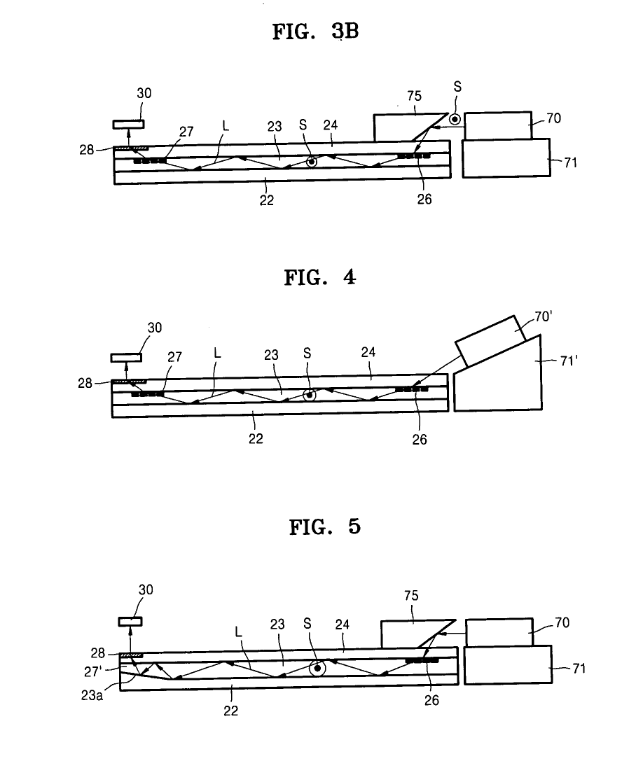

A variety of exemplary embodiments of a near field light emitter for the HAMR head according to the present invention will be described with reference to FIGS. 3A through 8.

FIG. 3A is a schematic perspective view of a near field light emitter according to an exemplary embodiment of the present invention, and FIG. 3B is a sectional view taken along a line III-III of FIG. 3A.

As described above, a near field light emitter 20 includes a waveguide 21, an NFE pole 30, and a light source 70.

The waveguide 21 includes a cladding layer 22, a core layer 23, and a cover layer 24 sequentially stacked on a substrate 11. Since the waveguide transmits light using total internal reflection, the refractive indexes of the cladding layer 22 and the cover layer 24 should be greater than that of the core layer 23. For that purpose, each of the cladding layer 22 and the cover layer 24 may be formed of one material selected from the group consisting of SiO₂, CaF₂, MgF₂, and Al₂O₃, and the core layer 24 may be formed of one material selected from the group consisting of SiN, Si₃N₄, TiO₂, ZrO₂, HfO₂, Ta₂O₅, SrTiO₃, GaP, and Si. When GaP or Si is used for the core layer 23, the light source 70 may be a light source emitting near infrared light rather than visible light having high absorption for GaP or Si.

Also, the near field light emitter 20 may further include an input coupler 26 for coupling light emitted from the light source 70 to the waveguide 21. The input coupler 26 is located in a portion of the waveguide 21 that is close to the light source. The input coupler 26 may be a grating coupler consisting of a plurality of grooves 26a formed on one side of the waveguide. The grooves 26a may be formed long in a direction perpendicular to the ABS 81 in order to diffract the light emitted from the light source 70 to the core layer 23. This input coupler 26 is formed at a boundary between the core layer 23 and the cover layer 24. The input coupler 26 may be formed at a boundary between the cladding layer 22 and the core layer 23 depending on a coupling method.

Furthermore, the input coupler 26 may include various couplers besides the grating coupler. For example, a prism coupler may be used. Still further, the light emitted from the light source 70 may directly butt on the core layer 23 of the waveguide 21 and be coupled there (direct butt-end coupling), without the input coupler 26.

A reference numeral 75 denotes an optical path converter reflecting the light emitted from the light source 70 toward the input coupler 26. When the light source 70 is located in parallel to the waveguide 21 as in the present exemplary embodiment, the optical path converter 75 changes the optical path of the light emitted from the light source 70 and allows the light to be obliquely incident to the waveguide 21. Though a mirror is illustrated as the optical path converter 75, the optical path converter 75 is not limited to this mirror. For example, for modification of the optical path converter 75, a total internal reflection prism may be used. Furthermore, referring to FIG. 4, a light source 70′ may be obliquely installed with respect to a sub-mount 71′ such that light emitted from the light source 70′ is directly coupled to the input coupler 26 without an optical path converter. In this case, the sub-mount 71′ includes an inclined installation surface so that the light source 70′ is obliquely installed with respect to the sub-mount 71′.

Also, the near field light emitter 20 may further include output couplers 27 and 28 for coupling light transmitted through the waveguide 21 to the NFE pole 30. The output coupler is located at a portion of the waveguide 21 that is close to the NFE pole 30. The output coupler includes a first output coupler 27 for emitting light transmitted through the waveguide to the outside of the waveguide, and a second output coupler 28 for condensing light emitted from the first output coupler 27 and illuminating the condensed light to the NFE pole 30.

FIGS. 3A, 3B and 4 illustrate embodiments of the output couplers 27 and 28, which are exemplified as a grating coupler.

The first output coupler 27 is formed at a boundary between a portion of a core layer 23 adjacent to the NFE pole 30 and a cover layer 24. At this point, grooves 27a constituting the grating of the first output coupler 27 may be formed long in a direction perpendicular to an ABS 81 in order to emit light transmitted within the core layer 23 to a direction of the NFE pole 30.

The second output coupler 28 is formed in a surface of the cover layer 24 that faces the NFE pole 30. At this point, grooves 28a constituting the grating of the second output coupler 28 may be formed long in a direction in parallel to the ABS 81 in order to allow light to be incident onto the NFE pole 30 at a certain angle. It is possible to control the angle of the light incident onto the NFE pole 30 by controlling the interval of the grating and changing diffraction degree. Furthermore, it is possible to condense light that has passed through the output couplers 27 and 28 by changing a diffraction pattern, e.g., by sequentially increasing or decreasing the grating intervals of the output couplers 27 and 28.

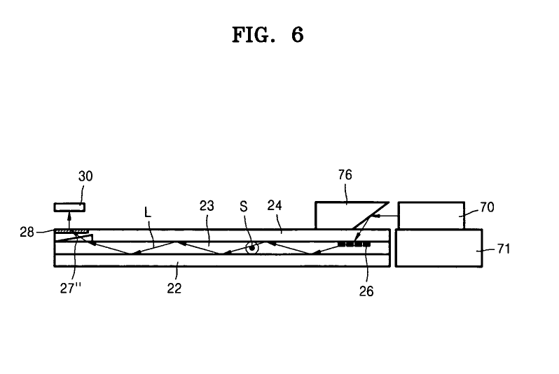

The first output coupler 27 may be a tapered coupler or a prism coupler illustrated in FIGS. 5 and 6, respectively, besides the grating coupler.

FIG. 5 illustrates the taper coupler is used for the first output coupler according to an exemplary embodiment of the present invention. Referring to FIG. 5, the first output coupler 27′ is the taper coupler where a portion 23a of the rear side of the core layer 23 that is opposite to the surface of the core layer 23 that faces the NFE pole 30 is inclined such that the thickness of the core layer 23 gradually reduces. In this case, light propagating through the core layer 23 using total internal reflection passes through the first output coupler 27′, penetrates the cover layer 24, and propagates toward the second output coupler 28. That is, light that passes through the first output coupler 27′ is reflected at the inclined surface 23a of the core layer 23, so that the incident angle of light propagating toward the cover layer 24 reduces. Accordingly, light incident onto the cover layer 24 at an angle less than a critical angle, which generates total internal reflection, is not total-internal reflected but penetrates from the core layer 23 to the cover layer 24.

FIG. 6 illustrates a prism coupler is used as the first output coupler. Referring to FIG. 6, the first output coupler 27″ is the prism coupler formed on a portion of a core layer 23 that faces the NFE pole 30.

The first output coupler 27″ has a greater refractive index than that of a cover layer 24 such that total internal reflection does not occur at a boundary between the cover layer 24 and the core layer 23. For example, since the refractive index of the core layer 23 is greater than that of the cover layer 24, the first output coupler 27″ may be formed of the same material as that of the core layer 23.

Since the surface of the first output coupler 27″ that faces the NFE pole 30 is inclined with respect to the core layer 23, light propagating toward the first output coupler 27″ may be incident at an angle less than a critical angle, which generates total internal reflection in the core layer 24. Accordingly, light propagating through the core layer 23 using total internal reflection penetrates from the first output coupler 27″ to the cover layer 24, and propagates toward the second output coupler 28.

Also, a modification without the output couplers 27 and 28 may be realized. For example, when the NFE pole is formed to contact the end of the waveguide 21 that is located at the end of the ABS 81, the NFE pole 30 may directly contact the core layer 23, where light is directly coupled to the NFE pole 30.

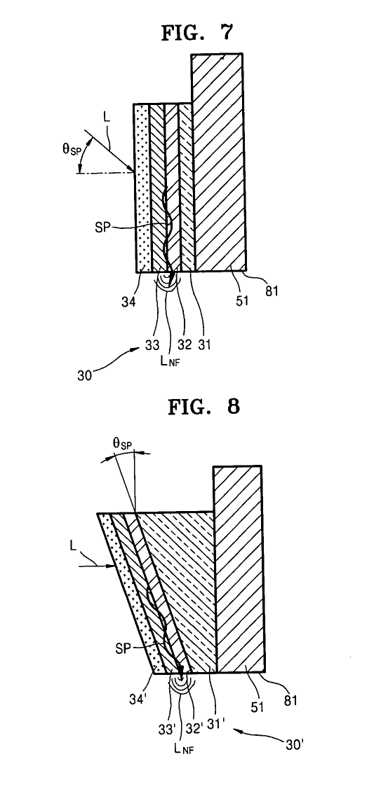

FIG. 7 schematically illustrates an NFE pole according to an exemplary embodiment of the present invention.

The NFE pole 30 includes a metal thin film layer 33 where an SP is generated by light illuminated through the waveguide 21. The metal thin film layer 33 may be formed of metal having excellent conductivity and selected from the group consisting of Au, Ag, Pt, Cu, and Al. The metal thin film layer 33 may have a thickness equal to or smaller than a skin depth so that excitation of an SP is easily generated. The NFE pole 30 having this metal thin film structure may emit near field light LNF without an aperture, and may be easily manufacture through a thin film manufacturing process.

When electromagnetic waves are illuminated onto the metal thin film layer 33, a free-electron gas existing on the surface of the metal thin film layer 33 vertically vibrates by an electric field generated by the illuminated electromagnetic waves and propagates along the boundary of the metal thin film layer 33. This vibration of surface charges (electrons) is called surface plasma vibration, and quantized vibration of these surface charges is called SP.

The NEF pole 30 may further include a first dielectric layer 32 covering the backside of the surface of the metal thin film layer 33 that receives illumination of light, and a second dielectric layer 34 covering the surface of the metal thin film layer 33 that receive the illumination of the light in order to increase a coupling efficiency between the SP and incident light. A reference numeral 31 represents a thermal conduction prevention layer, and blocks heat generated as light is illuminated onto the NFE pole 30 to prevent the heat from having adverse influence on the magnetism of a recording pole 51.

For effective excitation of the SP, it is required to allow the component size of a wave number vector horizontal to the incident boundary of incident light L to be identical to the size of a wave vector of the SP. The following Equation describes an excitation condition of the SP.

$$θ sp ≅ {sin}^{- 1} ( \frac{1}{{n}_{2}} \sqrt{\frac{{ɛ}_{1} Re ( {ɛ}_{m} )}{{ɛ}_{1} + Re ( {ɛ}_{m} )}} ) \qquad Equation 1$$

where θsp is a resonant angle and represents an incident angle of transverse magnetic (TM) mode light illuminated onto the NFE pole 30; n2 is the refractive index of the second dielectric layer; ε1 is the dielectric constant of the first dielectric layer; and Re(εₘ) is the real part of the dielectric constant of the metal thin film layer.

To satisfy the above-described excitation conditions, the second output coupler 28 may adjust its grating interval to allow light L to be incident onto the NFE pole 30 at an angel θsp.

FIG. 8 illustrates another exemplary embodiment where light is obliquely incident onto the NFE pole. Referring to FIG. 8, a second output coupler 28 does not control an incident angle, but instead, an NFE pole 30 is inclined with respect to a recording pole 51 to control an incident angle of light illuminated onto the NFE pole 30′, so that the light is incident onto the NFE pole 30′ at a resonant angle θsp. According to the present exemplary embodiment, a thermal conduction prevention layer 31′ is obliquely formed with respect to the recording pole 51, and the NFE pole 30′ is formed on the thermal conduction prevention layer 31′. The end of the NFE pole 30′ is located on the same plane as that of the ABS 81.

The waveguide structure through which TM-polarized light is illuminated onto the NFE pole will be described with reference to FIGS. 3A and 3B.

For efficient excitation of the SP, light illuminated onto the NFE pole 30 may be TM-polarized light, i.e., p-polarized light.

For that purpose, a light source 70 is installed such that the primary polarization component of light incident to an optical path converter 75 is s-polarized. When a laser diode is used as the light source 70, the light source 70 is installed in a parallel direction to the waveguide 21 as illustrated to allow s-polarized light to be incident to the waveguide 21.

The incident s-polarized light propagates as transverse electric (TE) mode light L within the waveguide 21 and travels up to the second output coupler 28. That is, the light L within the waveguide 21 is transmitted with the direction S of the electric field of the light perpendicular to the ABS 81.

Since the polarized light L is refracted again (toward the ABS 81) at the second output coupler 28, the light L may be converted into TM-mode light and illuminated onto the NFE pole 30. That is, the electric field of the light incident onto the NFE pole 30 is allowed to exist on a plane of incidence. Here, the plane of incidence is defined by a plane on which a line perpendicular to a plane on which light is illuminated and a vector pointing the progressing direction of incident light coexist. In FIG. 7, the plane of incidence is the same as the plane of the drawing.

As described above, the near field light emitter according to the present invention has a waveguide structure that allows TM-mode light to be illuminated onto the NFE pole 30, so that SP may be efficiently excited.

The excited SP propagates toward the end 30a of the NFE pole 30 that is close to the ABS 81. Since an electric field component illuminated onto the NFE pole 30 and contributing to the excitation of the SP has a direction perpendicular to the ABS 81, the SP more efficiently propagates toward the end 30a of the NFE pole 30.

The NFE pole 30 has a narrower width as it approaches the ABS 81. In this case, the speed of the SP is reduced as the area of the NFE pole 30 is reduced. Localized SP, whose intensity is strengthened, is excited at the end 30a, so that near field light L_{NF} (of FIG. 2) is emitted. Since the emitted near field light L_{NF} may have a beam size smaller than a diffraction limit, it is possible to increase the density of recording information by reducing a recording bit interval when recording magnetic information on the recording medium 90 (of FIG. 2).

The width W of the end 30a of the NFE pole 30 may be equal to or smaller than the track pitch of the recording medium 90. That is, the width W of the end 30a may be equal to or smaller than the width of the recording pole 51 (of FIG. 2). By doing so, it is possible to prevent the near field light L_{NF} from being illuminated onto other regions except a track on which magnetic recording is performed and thus recorded information is not damaged by thermal influence.

Referring again to FIG. 2, the near field light L_{NF} illuminated from the NFE pole 30 heats the local area of the recording layer 93 to reduce coercive force. As the recording medium 90 moves in a direction B, the heated local area is immediately moved to the end of the recording pole 51 and magnetized by leakage magnetic flux generated from the end of the recording pole 51. The leakage magnetic flux is induced by the induction coil 55 and changes the direction of a magnetic field, thereby sequentially changing the magnetization vectors of the recording layer and recording information. The induced magnetic flux comes out of the recording pole 51 and constitutes a closed loop that passes through the soft magnetic layer 92, the return pole 53, and the yoke 54. Since the near field light LNF generated from the NFE pole 30 drastically reduces as it is spaced farther from the NFE pole 30, the distance between the ABS 81 and the recording medium 90 may be maintained in a range of several-several tens of nm.

Since the near field light emitter including the waveguide may be manufactured together with other parts of the HAMR head through the thin film process, the manufacturing of the near field light emitter is easy, and miniaturization, light-weight, and a thin profile of optical parts constituting the near field light emitter may be achieved.

According to the above-described exemplary embodiments, though the near field light emitter and the recording unit are sequentially stacked on the substrate, the order of stacking them may change. Even in this exemplary embodiment, the HAMR head is mounted on the slider so that the recording medium is heated by the near field light emitter before magnetic recording is performed by the recording pole. Also, the HAMR head according to the present invention is not limited to vertical magnetic recording or horizontal magnetic recording.

As is apparent from the above descriptions, the HAMR head according to the present invention may have the following effects.

First, it is possible to manufacture the HAMR head including the near field light emitter without excessively changing the prior art process of manufacturing the magnetic recording head. Also, since the HAMR head is collectively manufactured through the thin film process, miniaturization, light-weight, and a thin profile of the HAMR may be achieved.

Second, it is possible to simplify a structure that transmits light up to the NFE pole and always maintain a constant optical coupling efficiency even when vibration or impulse occurs by installing the light source in the slider.

Third, it is possible to control an incident angel of light illuminated onto the NFE pole and illuminate TM-mode light, which may enhance the SP coupling efficiency of the light source.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A heat assisted magnetic recording (HAMR) head mounted in a slider having an air-bearing surface (ABS) the HAMR head comprising:
a recording unit which performs magnetic recording; and
a near field light emitter which illuminates near field light,
wherein the near field light emitter comprises:
a light source which is disposed on a side of the slider;
a waveguide, which is disposed on the side of the slider where the light source is disposed, has a side disposed on the ABS, and has the recording unit disposed on an upper portion of the waveguide; and
an near field light emission (NFE) pole interposed between the recording unit and the waveguide, and which generates near field light using light transmitted through the waveguide.

2. The HAMR head of claim 1, wherein the near field light emitter further comprises an input coupler disposed in a first portion of the waveguide to couple light emitted from the light source to the waveguide.

3. The HAMR head of claim 2, wherein the input coupler comprises a grating coupler comprising of a plurality of grooves formed in one side of the waveguide.

4. The HAMR head of claim 2, wherein the near field light emitter further comprises an optical path converter disposed between the light source and the input coupler.

5. The HAMR head of claim 2, wherein the light source is installed obliquely with respect to the waveguide, so that light emitted from the light source is directly incident to the input coupler.

6. The HAMR head of claim 1, wherein the near field light emitter further comprises an output coupler located in a second portion of the waveguide to couple light transmitted through the waveguide to the NFE pole.

7. The HAMR head of claim 6, wherein the output coupler comprises a first output coupler which emits the light transmitted through the waveguide to the outside of the waveguide.

8. The HAMR head of claim 7, wherein the first output coupler comprises a grating coupler formed by a plurality of grooves in the surface of the waveguide that faces the NFE pole.

9. The HAMR head of claim 7, wherein the waveguide comprises a cladding layer disposed on a substrate, a core layer disposed on the cladding layer to transmit light, and a cover layer disposed on the core layer; and
the first output coupler comprises a taper coupler where a part of the rear side of the core layer that is opposite to the surface of the core layer that faces the NFE pole is inclined to gradually reduce the thickness of the core layer.

10. The HAMR head of claim 7, wherein the waveguide comprises a cladding layer disposed on a substrate, a core layer disposed on the cladding layer to transmit light, and a cover layer disposed on the core layer; and
the first output coupler comprises a prism coupler where a part of the surface of the core layer that faces the NFE pole.

11. The HAMR head of claim 7, wherein the output coupler further comprises a second output coupler which condenses light from the first output coupler and illuminates the condensed light to the NFE pole.

12. The HAMR head of claim 11, wherein the second output coupler comprises a grating coupler formed by a plurality of grooves in the surface of the waveguide that faces the NFE pole.

13. The HAMR head of claim 12, wherein the grating of the second output coupler is formed long in a direction parallel to the ABS such that light from the first output coupler is obliquely incident onto the NFE pole.

14. The HAMR head of claim 1, wherein the NFE pole comprises a metal thin film layer where a surface plasmon is excited by light illuminated through the waveguide to generate a near field at the end of the metal thin film layer.

15. The HAMR head of claim 14, wherein the NFE pole further comprises a dielectric layer covering the metal thin film layer.

16. The HAMR head of claim 14, wherein the width of the NFE pole reduces as the NFE pole approaches the ABS.

17. The HAMR head of claim 14, wherein the end of the NFE pole exists on a same plane as that of the ABS.

18. The HAMR head of claim 1, further comprising a thermal conduction prevention layer located between the recording unit and the NFE pole.

19. The HAMR head of claim 1, wherein the NFE pole is inclined with respect to the recording unit.

20. The HAMR head of claim 1, wherein the recording unit comprises:
a recording pole which magnetizes the recording medium;
a return pole which is spaced apart from the recording pole;
a yoke which magnetically connects the recording pole and the return pole; and
a sub-yoke which condenses a magnetic flux to an end of the recording pole,
wherein the NFE pole is located in a space formed at the end of the sub-yoke.
